(19) United States
(12) Patent Application Publication
(10) Pub. No.: US 2016/0008855 A1
(43) Pub. Date: Jan. 14, 2016

(54) APPARATUS FOR CONTINUOUS SEPARATION OF CLEANING SOLVENT FROM RINSE FLUID IN A DUAL-SOLVENT VAPOR DEGREASING SYSTEM

(71) Applicant: KYZEN CORPORATION, Nashville, TN (US)

(72) Inventors: Kyle J. Doyel, Franklin, TN (US); Michael L. Bixenman, Old Hickory, TN (US); Ram Wissel, Franklin, TN (US); Alan William McCready, Gilmanton, NH (US); Robert Eugene Scheidegger, Bowling Green, KY (US); Eddie Joe McChesney, Bowling Green, KY (US); Kent Dwayne Tedder, Bowling Green, KY (US)

(21) Appl. No.: 14/635,169

(22) Filed: Mar. 2, 2015

Related U.S. Application Data
(62) Division of application No. 13/773,735, filed on Feb. 22, 2013.
(60) Provisional application No. 61/684,900, filed on Aug. 20, 2012.

(51) Int. Cl. B08B 3/14; B08B 3/08

(52) U.S. Cl. CPC B08B 3/14; B08B 3/08

(57) ABSTRACT

A method for cleaning a precision component which includes the steps of immersing the component in a heated solvating agent disposed in a pre-clean module tank to thereby remove an adherent contaminant; treating the component with a rinsing solvent to remove any remaining contaminants and residual solvating agent in a separate rinse degreaser whereby contaminants removed from the component collect in the rinse degreaser; and removing contaminated solvent from the rinse degreaser to a micro-still to separate the contaminants from the rinse solvent and direct the purified rinse solvent to the rinse degreaser. An apparatus is also provided for cleaning contaminants from a precision component including a pre-clean module tank containing a heated solvating agent, a degreaser containing a rinsing solvent, and a micro-still which separates the contaminants from the rinsing solvent and directs the purified rinsing solvent to the rinse degreaser.

### CROSS-REFERENCE TO RELATED APPLICATION

The present application claims priority to U.S. Provisional Application No. 61/684,900, filed Aug. 20, 2012, and entitled “Method and Apparatus for Continuous Separation of Cleaning Solvent from Rinse Fluid in a Dual-Solvent Vapor Degreasing System”, which is hereby incorporated by reference to the extent it is not inconsistent with the present disclosure.

### FIELD OF THE INVENTION

This invention relates to a method and apparatus for continuously separating contaminants from rinse fluid in a system for cleaning electronic and other components.

BRIEF SUMMARY OF THE INVENTION

In the manufacture of various products, especially electronic components such as circuit boards, medical devices, aerospace components, and military components, dual-solvent cleaning systems are used. Typically, a first solvent (also referred to as a “solvating agent”) is used to remove adherent soils such as solder flux, oils, lubes, and the like, and then a second solvent (also referred to as a “rinsing agent”) is used to rinse the product. In so doing, a quantity of the cleaning solvent and the manufacturing detritus collects in the rinse solvent. The rinse solvent must be periodically purged of these contaminants without causing a costly shut-down of the line.

The present invention is based on a dual-solvent process performed on a continuous basis during system operation to automatically separate the multiple solvents and contaminants while reclaiming the expensive rinse solvent for re-use in the degreaser. The process would yield a high percentage of reclaimed solvent at a quality so as not to affect cleaning actions, cause any damage to the solvent, equipment, and products being cleaned, and automatically segregate the waste stream for periodic removal from the system. This dual-solvent process incorporates an initial cleaning step using a solvating agent in a spray-under-immersion, ultrasonic or otherwise agitated process in one type of application specific chemistry followed by a second different solvent process for secondary clean and rinse action to remove residual contaminants or solvating agent.

This cleaning module process will provide initial stage of soils removal creating a lesser loading on the secondary rinse solvent thus extending solvent bath life while enhancing cleanliness levels.

The present invention utilizes a combination of process steps to effectively remove adherent soils from substrates. The term “substrate” is used herein in a broad sense to designate any device or article of manufacture which may be subject to contamination by unwanted materials. Thus, the term “substrate” encompasses, for example, machine parts, tools, or electronic components such as printed circuit boards, medical devices, aerospace components, and military components. Likewise, the term “adherent soil” is also used in a broad sense to designate, for example, unwanted materials which are not easily removed from the substrate by ordinary mechanical means. Thus, the term “adherent soil” encompasses inorganic and organic materials, for example, greases, waxes, oils, adhesives, rosin and resin based fluxes. Applicants contemplate, however, that the invention will find particular utility in connection with the cleaning of rosin and or resin fluxes from printed circuit boards and in connection with cleaning of wax, grease and/or oils from machine parts.

The solvating agent used in the present invention is one or more cleaning agents which are well-known in the art. Examples of such cleaning agents are those taught in Bixenman et al. U.S. Pat. No. 5,128,057 which is incorporated herein by reference in its entirety; Doyel et al. U.S. Pat. No. 7,288,511 B2 which is incorporated herein by reference in its entirety; cleaning agents taught by Hayes et al. in U.S. Pat. No. 5,679,175, from Col. 4, line 64, to Col. 5, line 12, which portions are hereby incorporated herein by reference; and those taught in Doyel et al. Patent Publication No. 20120152286 which is hereby incorporated by reference in its entirety herein. The cleaning agents may also have other desirable features and characteristics. For example, the solvating agent preferably will not adversely affect the strength, integrity or operability of the materials of construction of the substrate or the components thereof With respect to substrates comprising a printed circuit board, the solvating agent is preferably inert with respect to and not a solvent for epoxy resin impregnated fiberglass. The solvating agents also preferably are low in surface tension to improve processing characteristics and low in toxicity and possess a high flashpoint to improve safety characteristics. It is highly preferred that the solvating agents are benign to the atmosphere, soil and water. Chemical and photochemical stability are also other preferred features of the solvating agents. An additional desirable characteristic of the solvating agent is a boiling point that is matched, by one skilled in the art, to the boiling point of the rinsing agent which will facilitate enhanced recovery of the rinsing agent.

The rinsing agents also preferably have little or no known tendency to cause depletion of the ozone layer. More particularly, it is highly preferred that the rinsing agents have an ozone depletion factor (ODP) of no greater than about 0.15, more preferably no greater than about 0.05, and even more preferably of about zero. Ozone depletion factors are well-known measures of the negative effect volatile materials have on the ozone layer of the earth.

It should be appreciated by those skilled in the art that the rinsing agents currently used are relatively benign to atmospheric ozone at least in part because of the absence or reduced presence of chlorine in the molecules making up the rinsing agent. However, it will also be appreciated that the reduced chlorine content results in a decrease in the ability of the rinsing agent to solvate many adherent soils, including rosin solder flux. Nevertheless, the relatively low solvating power of the preferred rinsing agents is not detrimental to the cleaning effectiveness of the methods of the present invention. Accordingly, it will be understood that the present rinsing agents wash the solvating agent from the substrate to be cleaned, and it is not required that the rinsing agents have any ability to solvate the adherent soil, although this ability may be present in certain embodiments of the invention.

The rinsing agents used in the present invention may also have other desirable and beneficial characteristics. For example, the rinsing agent preferably does not adversely affect the strength, integrity or operability of the materials of construction of the substrate of the components thereof With respect to substrates comprising a printed circuit board, the rinsing agent is preferably inert with respect to and not a solvent for epoxy resin impregnated fiberglass.

The rinsing agents are also preferably low in toxicity and possess a high flashpoint to improve safety characteristics. It is also highly preferred that the rinsing agents are benign to the atmosphere, soil and water. Chemical and photochemical stability are also other preferred features of the rinsing agents. Each of the characteristics noted above with respect to the rinsing agent is equally preferred for the rinsing composition as a whole. Additional desirable characteristics of the rinsing agent should be apparent to those skilled in the art, such as a boiling point and properties at the boiling point that facilitates in the separation of the rinsing agent from the cleaning agent.

Thus, the present invention, in one aspect, is an apparatus for cleaning contaminants from a precision component comprising:
a. a pre-clean module tank containing a heated solvating agent which removes contaminants from the precision component,
b. a vapor degreaser serving as a rinse tank containing a rinsing agent which removes residual solvating agent and adherent soils from the precision component, and
c. a micro-still which separates said residual solvating agent and adherent soils from the rinsing agent, directs the rinsing agent back to the rinse tank, and directs the residual solvating agent and contaminants to waste disposal.

In the apparatus of the present invention, the rinse tank is operatively connected to the micro-still to convey rinsing agent contaminated with residual solvating agent and adherent soils carried over from the pre-clean module tank and to convey rinsing agent back to the rinse tank.

In another aspect of the present invention, a method is provided for continuously separating contaminants from rinse solvent in a system for cleaning electronic and other components comprising:
a. treating a contaminated substrate that has been subjected to treatment with a solvating agent with a rinsing solvent to remove any remaining contaminants and residual solvating agent in a separate rinse tank whereby contaminants removed from the component collect in the rinse tank; and
b. removing contaminated rinsing solvent from the rinse tank to a micro-still to separate the contaminants from the rinsing solvent, direct the rinsing agent back to the rinse tank, and direct the residual solvating agent and contaminants to waste disposal.

In still another aspect of the present invention, a method is provided for cleaning a precision component comprising:
a. immersing the component in a heated solvating agent disposed in a pre-clean module tank to thereby remove an adherent contaminant;
b. treating the component with a rinsing solvent to remove any remaining contaminants and residual solvating agent in a separate rinse degreaser whereby contaminants removed from the component collect in the rinse degreaser; and
c. removing contaminated rinsing solvent from the rinse degreaser to a micro-still to separate the contaminants from the rinsing solvent and direct the rinsing solvent to the rinse degreaser.

In a preferred embodiment of the present invention, the step of treating the component with a rinsing agent comprises:
d. subjecting the component to a pre-soak action by exposing said component to hot vapors of a rinsing agent disposed on a rinse degreaser;
e. immersing the component in boiling rinsing agent disposed in a boil sump to thereby remove any remaining adherent soils and residual solvating agent; and
f. removing the component from the boil sump and immersing the component in purified solvent disposed in a rinse chamber.

### BRIEF DESCRIPTION OF THE DRAWINGS

FIG. 1 is a schematic view of a cleaning system of the present invention showing the cleaning and rinsing and degreasing modes; and

FIG. 2 is a flow diagram showing the steps of cleaning, rinsing, and solvent recovery.

### DETAILED DESCRIPTION OF THE PREFERRED EMBODIMENTS

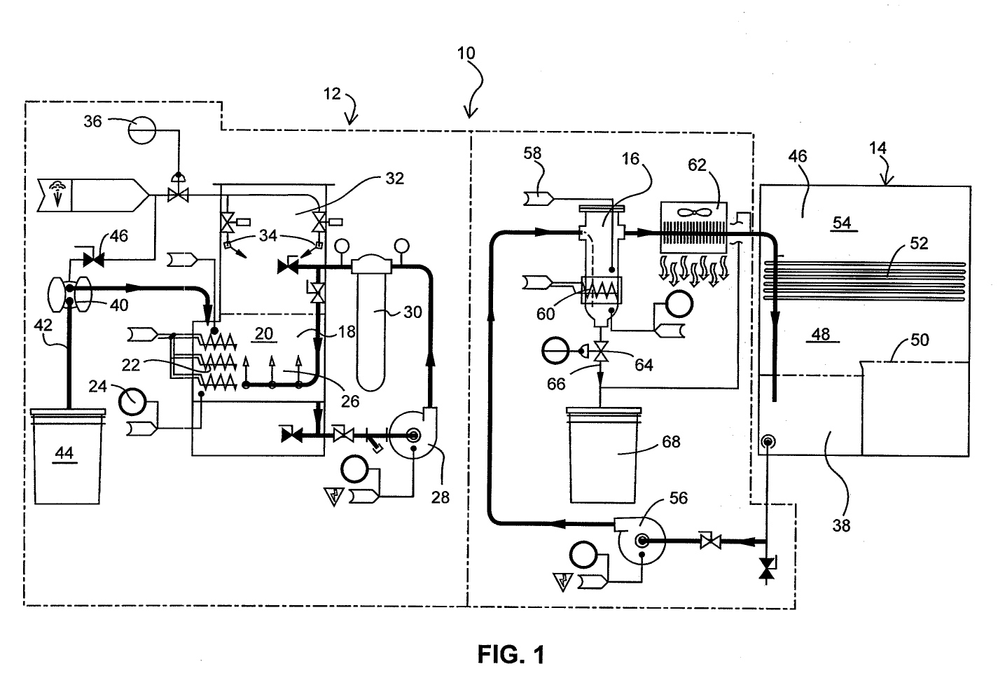

A dual-solvent cleaning system 10 according to the present invention is shown in FIG. 1. The dual-solvent cleaning system 10 broadly comprises a pre-clean module tank 12 and a rinse degreaser 14. The micro still 16 is preferably contained within the cabinet of the pre-clean module 12 for continuous low volume distillation of the solvent. It will be appreciated by those skilled in the art that the apparatus described herein can be constructed of any suitable material well-known in the art such as a stainless steel or Hastelloy® (a registered trademark of Haynes International, Inc.; the trademark is applied as the prefix name of a range of twenty two different highly corrosion-resistant metal alloys called “superalloys”.)

### Stage #1 Pre-Cleaning Process Cycle:

The workpiece to be cleaned is lowered via a material handling system (not shown) into an immersion chamber 18 in the pre-clean module tank 12 where it is exposed to heated solvating agent 20 to achieve a “soak” action while in the tank. The material handling system is of a type well-known in the art which could be a carrier such as a rack or basket lowered into the tank manually or controlled by an automated system, all of which are well-known in the art. The solvating agent 20 is heated by electric immersion heaters 22 installed in a tank off-set with thermostatic control 24. By off-setting the heaters 22, they are shielded by an alcove to prevent entering parts/baskets from inadvertently coming into contact and possibly damaging the heaters. The composition of the solvating agent 20 is specific to the type of substrate and soil and is well-known in the art. The composition of the solvating agent may contain, but is not limited to, one or more distinct phases, or contain additives that modify the reactivity, solubility parameters, flashpoint, acidity or alkalinity, boiling point, and various other chemical and physical properties, that should be known to those skilled in the art.

The heated solvating agent 20 in the immersion chamber 18 removes adherent soils from the surfaces of the dirty parts. Depending on the nature of the adherent soil, the solution exercises a solvent action or a chemical reaction of the cleaning agent with the adherent soil to be removed. In some applications the fluid being used reacts chemically with the adherent soil to form an emulsion, or to soften them for ease of future release from the substrate with the rinse solvent.

While the workpiece is submerged in the solvating agent 20, spray-under-immersion action 26 in the liquid chamber 18 is used as a mechanical aide to remove particulate matter and adherent soil from the surfaces of the substrate. It is to be noted that spray-under-immersion activity in relation to the effectiveness on the parts being cleaned may be affected by the parts exposure/racking/basket design. The immersion spray headers 26 are most commonly mounted on the bottom of the tank to provide an upward directional flow of heated solution to create a turbulent cleaning activity zone in the center of the tank. The heated solution is recirculated by a sealed pump 28 thru a filtration system 30 to remove displaced contaminants from the bath as the fluid is being recirculated and protect the spray nozzles.

The immersion cycle duration is to be determined by the user based on desired cleaning results. Once the immersion soak in solvating agent 20 with spray-under-immersion action 26 is completed, the workpiece is raised into the freeboard area of the machine 32 where it will be allowed to dwell for gravity drainage over the tank. This action allows solution drainage from the parts and workpiece basket back into the process tank to reduce carry-out/solution conservation.

Optional compressed air sweep headers 34 (controlled by the material handling system for location and duration thru a solenoid 36) can be installed in the tank to aid in fluid removal from the parts/baskets thus reducing solution carry-out and fugitive emissions if desired. Once this is completed, the workpiece can be removed from the system 12 and transferred to the next step in the process.

After the workpiece has been cleaned and removed from the pre-cleaning module 12, there will be a small amount of solution carried out on the workpiece (parts/baskets). As these items are conveyed into the rinse degreaser 14 for that process cycle, the residual carry-out will be deposited into the rinse degreaser boil sump 38.

Thus the solution level in the cleaning module 12 will begin to decrease in volume over time. In order to maintain the normal solution operational level, a transfer pump 40 is connected via a suction hose 42 to the virgin solution container 44.

The standard transfer pump 40 is a pneumatic pump and when a manually operated compressed air supply valve 46 is opened, this pump will pull new solution from the container 44 and transfer it into the pre-clean module immersion sump 18. This transfer pump 40 is manually controlled by the operator based on liquid level in the module tank 12 as periodically observed by the operator. The chemical make-up can also be performed automatically as an option.

### Stage #2 Rinse Degreaser Process Cycle

After the workpiece is removed from the pre-cleaning module 12, it is transferred to the rinse degreaser 14 for a secondary cleaning/rinsing process. Once over the degreaser 14 it is lowered into the degreaser tank 46 where it is exposed to hot solvent vapors 48 for a “pre-soak” action while being transferred down into the boil sump 38. The workpiece is transferred downward and immersed in the boil chamber 38 of the degreaser. The boiling solvent in this chamber removes any remaining contaminants and residual solvating agent from the surfaces of the parts. The turbulence created by the boiling solvent in chamber 38 creates the mechanical action to scrub the parts to enhance the cleaning process. Additionally, the degreaser may have ultrasonic or other agitation capability in the boil sump 38. Other additives may be incorporated into the rinsing agent by those skilled in the art to modify desirable properties such as, but not limited to, miscibility, boiling point, solvating character, and azeotrope or azeotrope like behavior.

After the workpiece is treated for a predetermined length of time depending on the nature of the substrate, the adherent soils, the type of solvent system being used, and the type of mechanical action (ultrasonics/spray-under-immersion/turbulence, etc.) being used in the process chambers, the workpiece is raised from the boil sump 38, transferred under the vapor line which is the vertical mid point of the primary condenser coils 52 between the vapor zone 48 and the freeboard zone 54, and immersed in the rinse sump 50 of the machine for a second total immersion in a purified rinsing solvent to enhance work cleanliness levels.

When the rinse cycle is completed, the workpiece is raised out of the liquid and allowed to dwell in the vapor zone 48 for a drainage dwell. Excess rinse solvent will drain by gravity from the parts/basket and fall back into the rinse tank for solvent conservation. Here the workpiece is re-heated by exposure to pure clean solvent vapors 48 for a final condensate rinse and drying effect.

When the condensate rinse is completed, the workpiece is raised into the freeboard area 54 of the machine where it will be allowed to dwell for a time equivalent to one-third of the condensate rinse/dry time or extended time to reduce any residual rinsing solvent carry-out, thus conserving rinsing solvent.

Once this is completed, the workpiece can be removed from the degreaser 14 and the process repeated as desired with new workpiece to be processed.

### Stage #3 Micro-Still Process Cycle

As the workpiece is being rinsed in the degreaser 14, the contaminants removed from the products by the solvating agent begin to increase in mass in the boil sump 38 over time. In order to maintain the solvent purity level within acceptable ranges so as not to affect cleaning and/or rinsing capabilities and vapor generation capacity, it is necessary to remove the contaminants from the boil sump 38 on a regular basis.

This is accomplished by the use of a solvent distillation system. A “Micro-Still” 16 is connected to the degreaser boil sump 38 for continuous low volume distillation of the contaminated rinsing solvent.

The Micro-Still 16 periodically receives contaminated rinsing solvent from a transfer pump 56 controlled by the still liquid level control 58. The still vessel is heated by a heater 60 to vaporize the internal solvent portion of the mixture. The adherent soils/contaminants typically will not vaporize at the applied lower temperature design range based on the type of solvent being used for the rinsing solvent and will thus remain in the vessel as the hot rinse solvent vapors rise and exit thru vapor migration to the external heat exchanger/condenser 62.

This air cooled external condenser 62 lowers the hot solvent vapor temperature changing it to a liquid where it drains by gravity and flows through piping to the connected degreaser 14. The flow of distilled/recovered rinsing agent is directed into the degreaser boil sump 38 for blending with the existing solvent where it is vaporized during normal degreaser actions.

In the standard design, the Micro-Still and components described herein are contained in the cabinet of the pre-clean module 10 as shown in FIG. 1.

### Auto-Dump Feature:

Based on selected process parameters for the still vessel 16, a still cook-down will periodically be initiated whereas no further contaminated rinsing agent will be allowed to enter the micro-still vessel 16. The transfer pump 56 is automatically locked out. The existing fluid in the micro-still vessel 16 will continue to be heated by heater 60 until the majority/high yield of the recoverable rinsing solvent is expelled. The process parameters take into consideration the solvent being used, the type and volume of contaminants/adherent soils being removed from the recirculating rinse solvent stream, the elapsed time of system operation, the variation of contaminant/adherent soil loading based on variety of substrates being processed/variety of contaminants/adherent soils, end user preference for micro-still cook-down based on desired solvent purity levels, and substrate cleanliness levels.

Once the monitoring devices reach pre-set conditions, the heater 60 will be de-energized and a bottom dump solenoid valve 64 will be energized “open”. This bottom valve 64 is connected by flexible piping 66 to a waste container 68 that receives the still “bottoms” for periodical proper disposal by customer.

Once the auto-dump cycle has been completed for a predetermined period of time, the bottom valve 64 will automatically be closed. The program will then resume normal operation by re-filling the micro-still vessel 16 via transfer pump 56. Once the vessel level is at normal operational level as determined by liquid level sensor 58, the pump 56 will be de-energized and then the heater 60 will be energized to return the micro-still 16 to normal operations.

Once the micro-still 16 is up to heat and generating vapors, the transfer pump 56 will cycle as required to re-fill the still with contaminated rinsing solvent from degreaser boil sump 38.

This design automatically controls the micro-still operation, cook-down, and dump cycles while isolating the operator from the process. This function is displayed on the HMI screen for process monitoring.

### Micro-Still Solvent Cycle:

In conjunction, as the Micro-Still processes the contaminated rinsing solvent from the degreaser boil sump, rinsing solvent circulates from the degreaser to the micro-still back to the degreaser with a small amount being discarded periodically with the still bottoms. A certain amount of rinsing solvent will remain in suspension with the solvating agent and adherent soils/contaminants which are periodically removed from the still via the “auto-dump” cycle described above.

The micro-still vessel liquid volume will be automatically controlled as supplied from the degreaser. Thus the degreaser boil sump will need periodic make-up solvent contingent upon hours of operation, type/size/configuration of parts/baskets being processed, and still dump cycles.

### Summary of Solvent Flow

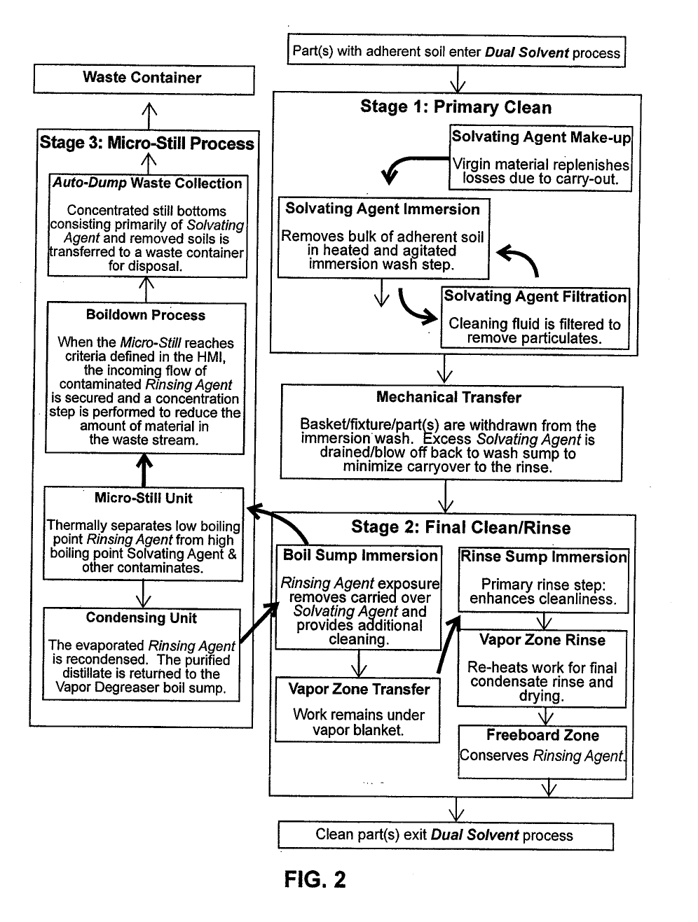

Referring to FIG. 2, it will be seen that at Stage 1 where the workpiece is immersed in solvating agent, virgin solvent is introduced as well as solvent which has been used and filtered. The workpiece is then moved to Stage 2 where it undergoes rinsing and additional cleaning in both with vapors and liquid rinsing agent.

Solvating agent and adherent soils which are carried over as well as rinsing agent are sent to the micro-still unit which thermally separates low boiling point rinsing agent from high boiling point solvating agent and other contaminates. The incoming contaminated rinsing agent is concentrated to reduce the amount of material in the waste stream. Evaporated rinsing agent is condensed and returned to the vapor degreaser boil sump. Concentrated still bottoms which are primarily solvating agent and removed soils is transferred to a waste container for ecologically acceptable disposal.

It is understood that the invention is not intended to be unduly limited by the illustrative embodiments and examples set forth herein and that such examples and embodiments are presented by way of example only. In the examples, all percentages are percentages by weight.

### EXAMPLE 1

To demonstrate the efficiency of the separation of the cleaning agent from the rinsing agent, the rinse degreaser was filled with 2,3-dihydrodecafluoropentane and brought to a boil at about 129° F. (54° C.). The Micro-Still was activated and the program controlled the addition of the contaminated rinsing solvent to the Micro-Still and the temperature of the Micro-Still. Every hour a 250-mL portion of solvating agent consisting primarily of tetrahydrofurfuryl alcohol, along with activators, surfactants, and corrosion inhibitors, the formulation of which is consistent with U.S. Pat. No. 5,128,057, was added to the rinsing agent. This 250 mL portion is greater than 25 times the volume of solvating agent that would be expected to be carried over when cleaning PCBs. Gas Chromatography samples of the rinsing agent in the boil sump before and after the addition of solvating agent consisting primarily of tetrahydrofurfuryl alcohol, along with activators, surfactants, and corrosion inhibitors, the formulation of which is consistent with U.S. Pat. No. 5,128,057, as well as the distillate from the Micro-Still and the bottoms from the Micro-Still. The Micro-Still was able to concentrate the adherent soils and solvating agent consisting primarily of tetrahydrofurfuryl alcohol, along with activators, surfactants, and corrosion inhibitors, the formulation of which is consistent with U.S. Pat. No. 5,128,057 to a purity of less than 2%, by weight, contamination of the rinsing agent, significantly reducing the amount of valuable rinsing agent that would be discarded when these still bottoms are discarded as waste. The distillate from the Micro-Still was essentially, pure rinsing agent (less than 1% by weight solvating agent and adherent soil contamination), proving that the Micro-Still does effectively remove the solvating agent and adherent soils from the rinsing agent.

### EXAMPLE 2

To further illustrate the various cleaning agents and solvating agents that may be used in this process, the rinse degreaser was filled with ethyl nonafluorobutylether and brought to a boil at about 172° F. (78° C.). The Micro-Still was activated and the program controlled the addition of the contaminated rinsing solvent to the Micro-Still and the temperature of the Micro-Still. Every hour a 250-mL portion of solvating agent consisting primarily of 3-methoxy-3-methyl-1 -butanol, with small amount of tetrahydrofurfuryl alcohol, surfactants, activators, and corrosion inhibitors, the formulation of which is consistent with Doyel et al. U.S. Pat. No. 6,130,195, which is embodied herein in its entirety. Gas Chromatography samples of the rinsing agent in the boil sump before and after the addition of solvating agent consisting primarily of 3-methoxy-3-methyl-1-butanol, with small amount of tetrahydrofurfuryl alcohol, surfactants, activators, and corrosion inhibitors, as well as the distillate from the Micro-Still and the bottoms from the Micro-Still. The Micro-Still was able to concentrate the adherent soils and solvating agent consisting primarily of 3-methoxy-3-methyl-1-butanol, with small amount of tetrahydrofurfuryl alcohol, surfactants, activators, and corrosion inhibitors to a purity of less than 2%, by weight, contamination of the rinsing agent, significantly reducing the amount of valuable rinsing agent that would be discarded when these still bottoms are discarded as waste. The distillate from the Micro-Still was essentially, pure rinsing agent (less than 1% by weight solvating agent and adherent soil contamination), proving that the Micro-Still does effectively separate the solvating agent and adherent soils from the rinsing solvent.

While there are shown and described present preferred embodiments of the invention, it is to be distinctly understood that the invention is not limited thereto but may be otherwise variously embodied and practiced within the scope of the following claims. Various modifications and alterations of this invention will be apparent to those skilled in the art without departing from the scope and spirit of this invention.

1. An apparatus for cleaning contaminants from a precision component comprising:
a. a pre-clean module tank containing a heated solvating agent which removes contaminants from said precision component,
b. a vapor degreaser serving as a rinse tank containing a rinsing agent which removes residual solvating agent and adherent soils from said precision component, and
c. a micro-still which separates said residual solvating agent and adherent soils from said rinsing agent, directs said rinsing agent back to said rinse tank, and directs said residual solvating agent and contaminants to waste disposal.

2. An apparatus as defined in claim 1, wherein said rinse tank is operatively connected to said micro-still to convey rinsing agent contaminated with solvating agent and residual contaminants carried over from said pre-clean module tank and to convey rinsing agent back to said rinse tank.

3-5. (canceled)

6. An apparatus for cleaning contaminants from a precision component as defined in claim 1, further comprising a condenser, wherein said micro-still distils said rinsing agent and directs said rinsing agent back to said rinse tank through said condenser.

7. An apparatus for cleaning contaminants from a precision component as defined in claim 1, further comprising monitors of process conditions pursuant to predetermined parameters, wherein said micro-still is energized or de-energized responsive to said monitors.

8. An apparatus for cleaning contaminants from a precision component as defined in claim 1, further comprising a pump operatively disposed between said rinse tank and said micro-still.

9. An apparatus for cleaning contaminants from a precision component as defined in claim 8, further comprising a still liquid level control, wherein said pump is activated responsive to the liquid level in said micro-still.
